(19) United States
(12) Patent Application Publication
(10) Pub. No.: US 2014/0027388 A1
(43) Pub. Date: Jan. 30, 2014

(54) Water purification system

(71) Applicant: Jim Constant, Westmount (CA)

(72) Inventor: Jim Constant, Westmount (CA)

(21) Appl. No.: 13/998,008

(22) Filed: Sep. 23, 2013

Related U.S. Application Data
(63) Continuation-in-part of application No. 12/807,542, filed on Sep. 7, 2010.

(51) Int. Cl. C02F 1/78

(52) U.S. Cl. CPC C02F 1/78
USPC 210/760; 210/177; 210/86

(57) ABSTRACT

A system and a method for treating water, the system comprising a first conduit having an inlet and an outlet with an ozone generator situated thereon, the ozone generator being operative to selectively treat water flowing through the conduit with the ozone, a sensor to measure the oxidation reduction potential of water, the sensor being operatively connected to the ozone generator, a holding tank situated at the outlet of the first conduit, the holding tank having a gas outlet conduit and a gas release valve, a second conduit extending from the holding tank, and an activated carbon filter on the second conduit.

This application is a Continuation-in-Part of application Ser. No. 12/807,542 filed Sep. 7, 2010

### FIELD OF THE INVENTION

The present invention relates to a system and a method and more particularly, relates to a water treatment system and a method for treating water.

### BACKGROUND OF THE INVENTION

The treatment of water for many purposes is well known in the art. In most industrialized countries, the water is treated centrally for distribution to residences and businesses. Normally, the treatment will include the use of chlorine to ensure that any bacteria in the water are killed.

In some instances, the central treatment of water is not possible, particularly in rural locations, and accordingly an alternative method of treating water is desirable.

### SUMMARY OF THE INVENTION

It is an object of the present invention to provide a system for the treatment of water and which system is compact and suitable for residential use.

It is a further object of the present invention to provide a method for the treatment of water wherein the water is effectively treated within a holding tank.

According to one aspect of the present invention, there is provided a water treatment system comprising a first conduit having an inlet and an outlet, an ozone generator situated on the conduit, the ozone generator being operative to selectively treat water flowing through the conduit with ozone from the ozone generator, a sensor to measure the oxidation reduction potential of the water, the sensor being operatively connected to the ozone generator, a holding tank situated at the outlet of the first conduit, the holding tank having a gas outlet conduit and a gas release valve, a second conduit extending from the holding tank, and an activated carbon filter on the second conduit.

According to a further aspect of the present invention there is provided a method for treating water comprising the steps of passing water through a conduit, measuring the oxidation reduction potential of the water in the conduit, generating ozone and introducing the ozone into the water when the oxidation reduction potential falls below a first predetermined value and until the oxidation reduction potential reaches a second predetermined value, discharging the water into a holding tank to permit the ozone to treat the water, and withdrawing water from the tank as needed and passing the water through an activated carbon filter.

The present invention provides for the treatment of water with ozone. The use of ozone for such purposes is known in the art. Ozone has an extremely high oxidating power. Ozone is a triatomic molecule consisting of three oxygen atoms. It is an ellotrope of oxygen and is much less stable than the diatomic ellotrope. Ozone is present in low concentrations in the earth's atmosphere. The injection of tiny ozone bubbles into water saturates every drop of the water. At this point, oxidation of iron, sulfur and manganese is immediate and produces micro-floculation.

Ozone is also a disinfectant that kills all e-coli bacteria on contact. As well, it will kill fungus, mold and yeast and will precipitate all the heavy metals. It is also useful for reducing scale build-up on equipment such as pipes and water heaters and to prevent staining on showers, sinks, bathtubs and toilets.

In operation, water will enter the first conduit from a suitable source thereof. The treatment process and system of the present invention may conveniently be utilized in residential applications, but could equally well be utilized in many other situations. As water passes through the conduit, it enters the holding tank. As the water rises, the air vent will evacuate excess air to avoid overly high pressures with low levels of water.

Subsequently, in one embodiment, the booster pump pushes the water through a venturi injector which creates a vacuum in order for the ozone to mix with the water. After the venturi injector, the ozonated water mixes with the incoming water from the well.

As the water reaches the level of the float air vent, the vent is closed, pressure builds up and the filling will be stopped at a pressure of approximately 50 to 80 psi and more preferably, around 60 psi. The ozonation process continues until the oxidation reduction potential sensor detects a level of approximately 800 mV at 0.9 ppm. The sensor naturally controls the ozone generator and the recirculation pump until the water is sterilized. While the water is sterile, it stays in the tank until it is ready to be consumed. When the water is needed, it will pass through the activated carbon filter to eliminate any residual ozone in the water.

While the water is being used, the pressure in the tank will drop. When it reaches a predetermined level (such as 30 psi) a signal is sent to the well pump to add water and keep filling the tank until the pressure reaches the upper predetermined level (approximately 60 psi).

When the oxidation reduction potential drops to a predetermined level (approximately 500 mV), the ozonation system and the recirculation pump start up and add ozone to the water in order to purify the same.

The ozone generator is known in the art and is typically used with an oxygen concentrator and an air dryer. Typically, dry air or oxygen is drawn into the ozone generator at which point the air is charged with a high voltage. As the concentrated oxygen is drawn into the ozone generator, the high voltage splits some oxygen molecules into oxygen atoms. This causes the atoms to react with the oxygen molecules to form triatomic ozone.

As aforementioned, the ozone injection is preferably done with a venturi injector but can also be done with a ceramic, or a stainless steel membrane diffuser. It has a water inlet and outlet and a suction to inject the ozone into the water. Typically, this is an efficient process as the water will dissolve approximately 90% of the ozone.

### BRIEF DESCRIPTION OF THE DRAWINGS

Having thus generally described the invention, reference will be made to the accompanying drawing illustrating an embodiment thereof, in which:

FIG. 1 is a schematic view of a water treatment system according to the present invention;

FIG. 2 is a schematic view of a further embodiment of a water treatment system according to the present invention;

FIG. 3 is a schematic view of a further embodiment of a water treatment system according to the present invention; and

FIG. 4 is a schematic view of a further embodiment of a water treatment system according to the present invention.

### DETAILED DESCRIPTION OF THE INVENTION

Referring to the drawings in greater detail and by reference characters thereto, there is illustrated a schematic of a water treatment system according to an embodiment of the present invention. The system includes a first conduit 10 which has an inlet 12 to which water is supplied. The water may be from a well or a municipal system or another suitable source.

A check valve 14 is mounted at inlet 10 such that no reverse flow of water may occur.

An air compressor 16 takes ambient air, compresses the same, and passes it through conduit 18 as indicated by arrow 20.

An oxygen concentrator 22 takes the compressed air and concentrates the oxygen component thereof. The concentrated oxygen is then passed through conduit 24 as indicated by arrow 26. An ozone generator 28 receives the concentrated oxygen from oxygen concentrator 22 and generates ozone. Typically, the ozone generator uses high voltage electricity.

The ozone is then pumped through conduit 30 as indicated by arrow 32 where the ozone injection apparatus provides for the injection of tiny ozone bubbles into the water. This may conveniently be done through a venturi 34 or an air diffuser. A water pump 36 is also provided, but it can be done without a water pump by using high pressure air injection.

An oxygen reduction potential sensor 38 is mounted on first conduit 10 and is operatively connected to an oxidation reduction potential controller 40. Controller 40 is connected to ozone diffuser by connection 42.

At the outlet 44 from ozone diffuser 34, there is flow as indicated by arrow 43 to a storage tank 46.

Storage tank 46 has a gas outlet conduit 48 at an upper portion thereof to permit outflow of gases from within storage tank 46. Mounted on gas outlet 48 is a gas release solenoid valve 50. The gas release solenoid valve 50 operates with a float value 64. Float value 64 may also be situated on the upper side of tank 46 at the desired water height level on a bulkhead fitting. When water level drops due to excessive gas pressure build-up, the float activates the solenoid valve so that it opens and releases the pent up air that caused the water level drop, the pressure in the tank drops and the well pump or solenoid activates, adding additional water to the tank, up until the water reaches and deactivates the float. It is understood that the ozone generator 28, oxygen concentrator 22 and compressor 16 are all activated as soon as fresh water from line 12 enters the system. Thus, the water level in tank 46 to be controlled adequately, requires two level controllers one for the gas evacuation and one for the maintenance of water level through pressure.

Also, pipe 48 being narrow and sealed on one end causes water to be trapped within, not letting it drain. To prevent this water entrapment, drain pipe 68 connects the float chamber with tank 46, forming an air passage that permits the water to drain in pipe 48.

An evacuation pipe 48 has a dual function, it acts as an air evacuation system and also as a level control for tank 46. The length that the pipe enters the tank is a level control.

At the lower end of storage tank 56, there is provided a second conduit from which the ozonated water may flow as indicated by arrow 54. The water flows to an activated carbon filter 56 and is then suitable for use as required.

A transfer conduit 58 extends between first conduit 10 and second conduit 52 and there is a one way valve thereon to permit flow from second conduit 52 back to first conduit 10.

A pressure switch 62 is mounted on second conduit 52 which may be connected to a well pump or a solenoid to tap water.

As may be seen from the above description, there is provided a water treatment system which does not require the use of a pump to pressurize the system; rather, the system employs the pressure supplied by the water as it arrives at the treatment system.

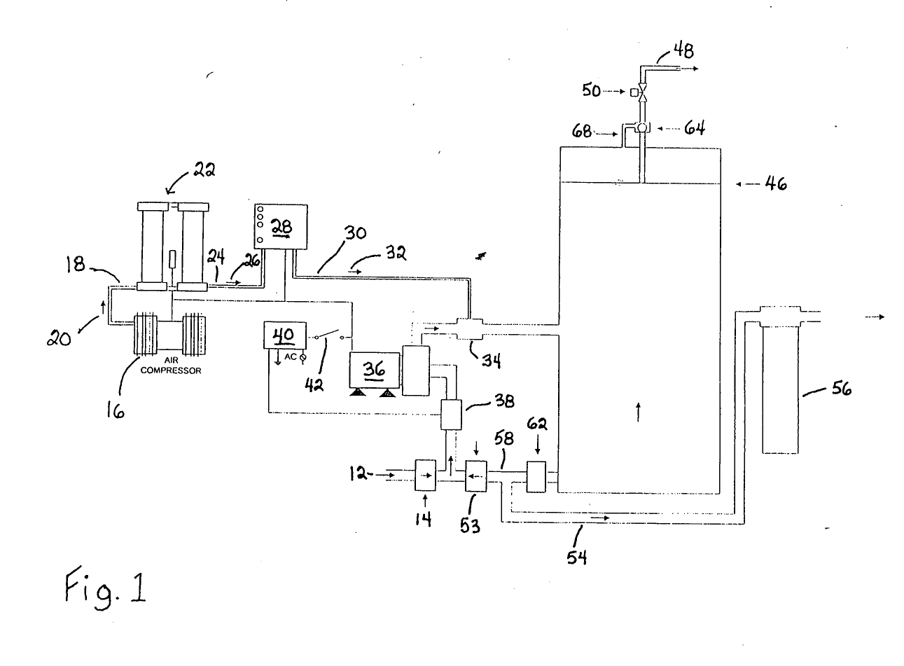

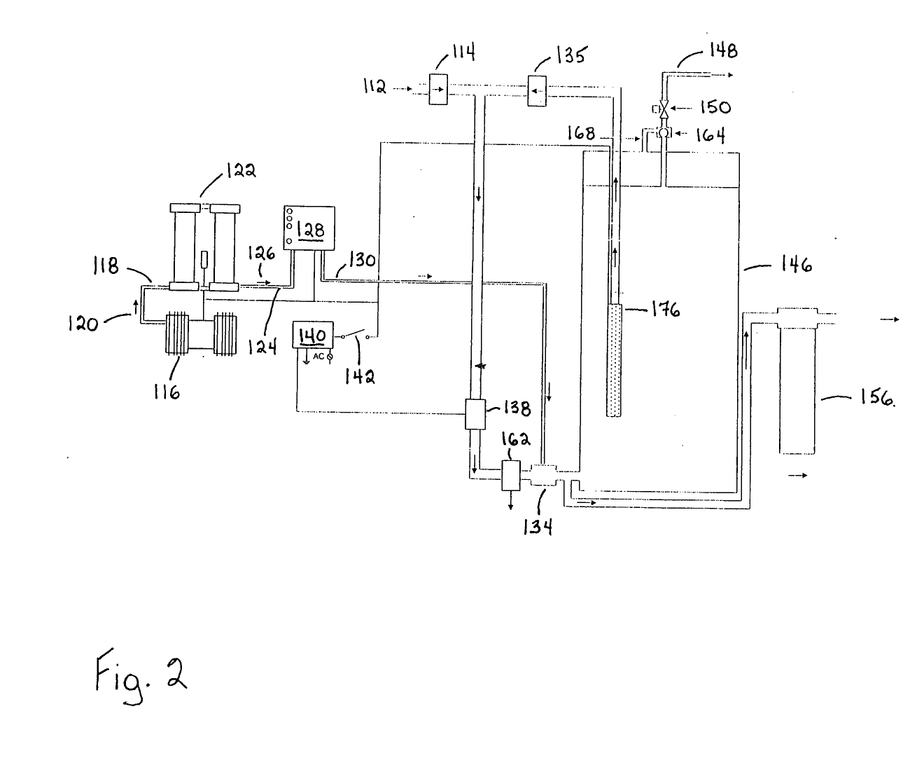

In the embodiment of FIG. 2, the reference numerals utilized are similar to those of FIG. 1 for similar components, but in the 100's. As will be seen from FIG. 2, the well or tap water inlet 112 has a check valve 114 mounted thereon. In this arrangement, pressure switch 162 is mounted at the inlet while an inline mixer 170 is provided. The ozone from ozone generator 128 is fed from line 130 to venturi 134. An inlet 176 extends from tank 146 through one way valve 135 to the inlet.

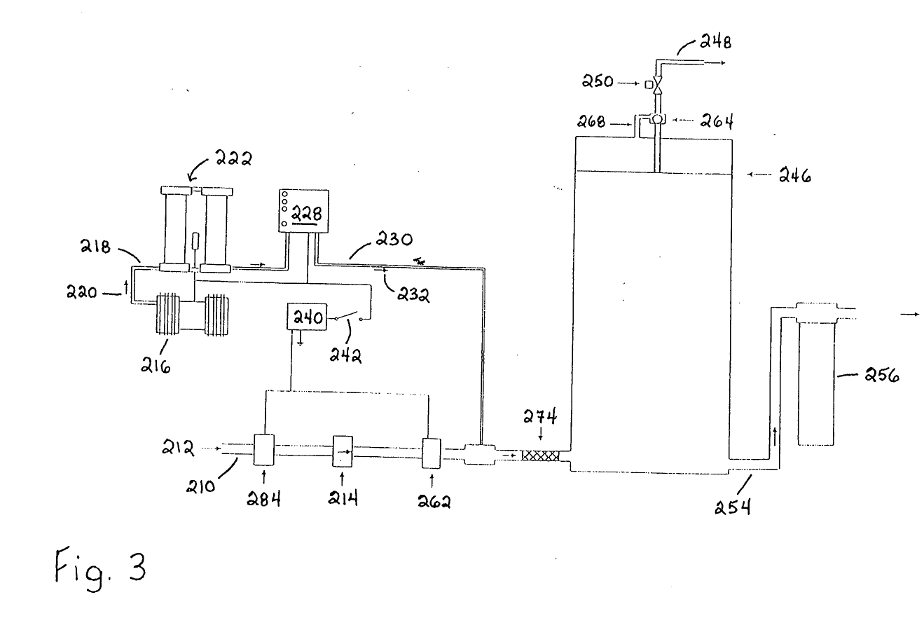

In the arrangement of FIG. 3, reference numerals in the 200's are used for similar components.

As may be seen from this drawing, pressure switch 262 is arranged to send a signal to a solenoid 284 or the well pump. There is provided an inline mixer 274.

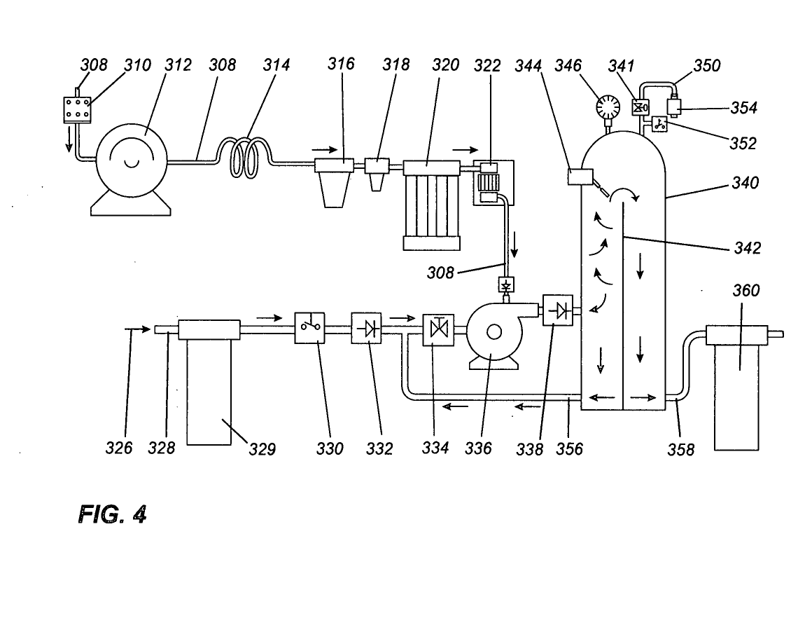

Turning to the embodiment of FIG. 4, there is illustrated a further system for the treatment of water. The system is designed to be self-contained and can be used either for a single residence or for a small building which may, for example, contain a plurality of independent living units.

The system contains a conduit for air which is generally designated by reference numeral 308. At the beginning of conduit 308, there is provided an air filter 310 through which air may flow on its way to an air compressor 312, the air flows through conduit 308 to an air cooler 314. Preferably, in the actual physical construction, air cooler 314 is placed within a pressurized reaction tank 340 as will be discussed hereinbelow.

The cooled air then goes further downstream to a moisture separator 316. A pressure regulator 318 is provided on conduit 308.

The dryer air then goes through an oxygen concentrator 320. Oxygen concentrator 320 preferably uses pressure swing absorption technology to generate oxygen. A typical arrangement includes cylinders filled with zeolite which under high pressure has the ability to absorb nitrogen and allow only oxygen to pass through. When the zeolite becomes saturated with nitrogen, the pressure in the cylinder is released to exhaust nitrogen to the atmosphere while another cylinder with fresh zeolite is used to continue to absorb nitrogen and permit the passage of oxygen. The cycle is continued through a number of such cylinders to produce a continuous flow of highly concentrated oxygen. Preferably, at the exit, one is provided with 90 to 95% pure oxygen at a flow rate typically of between 3 litres per minute to 5 litres per minute.

The concentrated oxygen is then passed further downstream through conduit 308 to an ozone generator 322. Ozone generator 322 uses the oxygen generated by the oxygen generator to produce highly concentrated ozone. Any type of ozone generators may be utilized with a typical ozone generator utilizing corona discharge inside a reaction chamber. The oxygen is fed into the reaction chamber and as it comes in contact with the corona discharge, it breaks down into oxygen atoms which subsequently recombine to form ozone molecules. Typically, such a system could produce 5 to 10 grams of ozone per hour at a concentration of 7 to 12%.

The system takes water from an untreated water source 326 and passes the same through conduit 328 and filter 329. On conduit 328 there is provided a flow switch 330 and a check valve 332. Further downstream, there is provided a flow control valve 334 followed by a pump 336.

Pump 336 is arranged to pump the untreated water and mix the same with ozone from conduit 308.

At the outlet side of pump 336, there is provided a check valve 338 through which the treated water may flow into a pressurized reaction tank 340. Pressurized reaction tank 340 includes an internal divider 342 such that the water has to follow a path sufficiently long to permit full reaction between the ozone and the water.

Associated with pressurized reaction tank 340 is a level switch 344 which detects when the water in the tank is at a certain level. In conjunction with the pressure gauge 346, there is a solenoid valve 341 which is fitted on a gas outlet line 350. The arrangement is such that when a certain level of water is detected within pressurized reaction tank 340, solenoid valve 341 is opened such that some of the gas within the pressurized reaction tank 340 is released. This permits more water to flow into the tank. The tank will also have a pressure switch 352 and an ozone neutralizer 354 mounted on gas outlet line 350.

A recirculation line 356 extends from the bottom of pressurized reaction tank 340 to flow control valve 334.

The treated water may be discharged through a discharge conduit 358 and through an activated carbon filter 360 which rids the treated water of any excess ozone as well as filtering out impurities and precipitate metals such as iron, manganese and arsenic. Such materials would ordinarily not be filterable without ozone's strong oxidation property.

It will be understood that the above described embodiment is for purposes of illustration only and that changes and modifications may be made thereto without departing from the spirit and scope of the invention.

I claim:

1. A water treatment apparatus comprising:
a pressure reaction tank, an inlet and an outlet to said pressurized reaction tank, said pressurized reaction tank having first and second compartments;
an air compressor;
an air cooler to cool compressed air from said air compressor, said air cooler being located within said pressurized reaction tank to permit cooling from water therein;
an oxygen generator in fluid communication with said air compressor to receive compressed air therefrom and to create oxygen enriched gas;
an ozone generator in fluid communication with said oxygen generator to receive said oxygen enriched gas therefrom and to create ozone enriched gas;
a water pump having an inlet and an outlet, a water conduit extending from said inlet to a water source;
a gas conduit from said ozone generator in fluid communication with said water pump; and
said water pump being in fluid communication with said inlet of said pressurized reaction tank.

2. The water treatment apparatus of claim 1 further including a flow switch on said water conduit.

3. The water treatment apparatus of claim 1 further including a pressure sensor for sensing pressure within said pressurized reaction tank.

4. The water treatment apparatus of claim 3 further including a water level sensor for measuring the height of water within said pressurized reaction tank.

5. The water treatment apparatus of claim 4 further including an activated carbon filter downstream of said pressurized reaction tank.

6. The water treatment apparatus of claim 5 further including a gas outlet located proximate an upper portion of said pressurized reaction tank, an ozone destruction unit associated with said gas outlet.

7. The water treatment apparatus of claim 1 further including a moisture separator downstream of said air compressor to treat compressed air.

8. The water treatment apparatus of claim 6, wherein said water level sensor is operatively connected to said gas outlet to permit discharge of gas from said pressurized reaction tank when a low water level is sensed.

9. The water treatment apparatus of claim 1 wherein said oxygen generator is a pressure swing adsorption oxygen generator containing cylinders to adsorb nitrogen.

10. A method of treating water comprising the steps of:
compressing air;
cooling said compressed air;
passing said compressed air through an oxygen generator to produce oxygen enriched air;
passing said oxygen enriched air through an ozone generator using a corona discharge to create ozone enriched air;
pumping water from a source thereof, treating said pumped water with said ozone enriched air and pumping said ozone treated water into a pressurized reaction tank;
circulating water within said pressurized reaction tank for a time sufficient for the dissolved ozone to react with the organic and inorganic matter present in the water; and
withdrawing treated water from said pressurized reaction tank;
wherein the step of cooling said air comprises using said water within said pressurized reaction tank for cooling.
